(19) United States
(12) Patent Application Publication
(10) Pub. No.: US 2020/0164699 A1
(43) Pub. Date: May 28, 2020

(54) NOISE REDUCING TREAD

(71) Applicant: Takashi Tezuka, Tokyo (JP)

(72) Inventor: Takashi Tezuka, Tokyo (JP)

(73) Assignee: COMPAGNIE GENERALE DES ETABLISSEMENTS MICHELIN, Clermont-Ferrand (FR)

(21) Appl. No.: 16/064,770

(22) PCT Filed: Dec. 16, 2016
(86) PCT No.: PCT/JP2016/087484

§ 371 Date: Jun. 21, 2018

(30) Foreign Application Priority Data
Dec. 25, 2015 (JP) PCT/JP2015/086592

(51) Int. Cl. B60C 19/00; B60C 11/13; B60C 11/04

(52) U.S. Cl. CPC B60C 19/002; B60C 11/1353; B60C 2011/1361; B60C 11/1307; B60C 2011/1338; B60C 11/047

(57) ABSTRACT

The tread has a primary groove which is provided with a plurality of closing devices including flexible fences. At least one first flexible fence has a thickness t1 and extends from a groove bottom. At least one second flexible fence has a thickness t2 and extends from one groove sidewall toward the other. The second flexible fence forms an angle A1 between an imaginary line connecting a free end of the second flexible fence and a bottom edge of the second flexible fence and an imaginary line extending from the free end of the top edge in a tire radial direction. A width wb1 of the first flexible fence is at most equal to 45% of a width WB of the primary groove, and a width wb2 of the second flexible fence at the bottom edge is at most equal to 40% of the width WB.

### CROSS-REFERENCE TO RELATED APPLICATION

The present application claims priority to PCT International Patent Application Serial No. PCT/JP2016/087484, filed Dec. 16, 2016, entitled “A NOISE REDUCING TREAD,” which claims the benefit of PCT/JP2015/086592, filed Dec. 25, 2015.

### BACKGROUND OF THE INVENTION

### 1. Technical Field

The present disclosure relates to a tread for a tire, in particular to a tread for a tire having a closing device enable to attenuate a noise generated by groove resonance in a primary groove.

### 2. Related Art

A groove resonance is generated by occurrence of resonance in an air column defined between a groove in a tread and a road surface in contact with the tire. The frequency of this groove resonance is dependent on a length of the air column formed between groove and the road surface in the contact patch.

This groove resonance has a consequence in an interior noise and an exterior noise on a vehicle equipping such tires, a frequency of which interior and exterior noise is often at around 1 kHz where human ear is sensitive.

In order to reduce such groove resonance, it is known to provide a plurality of closing devices in the form of a flexible fence made of rubber-based material and relatively thin in thickness in each primary groove. It is effective that each flexible fence covers all or at least major part of the sectional area in the primary groove. Each flexible fence can extend from a groove bottom, or be fixed onto at least one of a groove sidewall delimiting such primary groove. Because being relatively thin in thickness, each flexible fence has to bend for opening the primary groove section to flow water on the road surface, in particular on the wet road.

Thanks to such flexible fences, the length of the air column is reduced so as to be shorter than the total length of primary groove in a contact patch, which leads to change the frequency of groove resonance. This change of resonance frequency makes the sound generated by the groove resonance less sensitive to human ear.

For preserving function of drainage, in case driving in rainy weather, it is necessary that such flexible fence bends in a suitable way under the action of the pressure of water for opening the section of the primary groove. Several solutions have been proposed using this type of closing device to reduce groove resonance of the primary groove.

EP0908330 discloses, in FIG. 4a, a tread having principal (primary) groove equipping with fence portions with three flexible fences, wherein two flexible fences extend from the opposite groove sidewalls, another flexible fence extends from the groove bottom. However with such configuration, it is difficult to maintain satisfactory drainage capability, in particular when a groove depth is reduced with wear while maintaining satisfactory groove resonance reduction, as bending of the flexible fence extending from the groove bottom with hydrodynamic pressure occurs generally between middle part and bottom part of such flexible fence, and bending rigidity of such flexible fence increases with wear resulting disturbance of drainage. Moreover even in such situation, the flexible fences extending from groove sidewalls are not capable to provide extra drainage capability.

WO2013/072169 discloses, in FIG. 1, a tread having a groove providing with two flexible devices (flexible fences) both of which extend from each side of groove sidewalls, the flexible devices are provided with a notch on their bottom wall. However, with such configuration, coverage of the section of the groove via the flexible fence becomes weak due to the notch, and there is a difficulty for molding and demolding such flexible fences resulting decreased productivity of such tread.

### CITATION LIST

### Patent Literature

PTL 1: EP0908330
PTL 2: WO2013/072169

### Definitions

A “radial direction/orientation” is a direction/orientation perpendicular to axis of rotation of the tire. This direction/orientation corresponds to thickness direction of the tread.

An “axial direction/orientation” is a direction/orientation parallel to axis of rotation of the tire.

A “circumferential direction/orientation” is a direction/orientation which is tangential to any circle centered on axis of rotation. This direction/orientation is perpendicular to both the axial direction/orientation and the radial direction/orientation.

A “tire” means all types of elastic tire whether or not subjected to an internal pressure.

A “tread” of a tire means a quantity of rubber material bounded by lateral surfaces and by two main surfaces one of which is intended to come into contact with ground when the tire is rolling.

A “groove” is a space between two rubber faces/sidewalls which do not contact between themselves under usual rolling condition connected by another rubber face/bottom. A groove has a width and a depth.

A “primary groove” is a groove relatively wider width as primarily responsible for drainage. Often the case such primary groove extends towards circumferential orientation in general in a form of straight, zigzag and so on. The primary groove can also be understood as a groove extending towards oblique orientation having relatively wider width as primarily responsible for drainage.

A “contact patch” is a footprint of a tire mounted onto its standard rim as identified in tire standards such as ETRTO, JATMA or TRA, and inflated at its nominal pressure and under its nominal load.

### SUMMARY OF THE INVENTION

It is thus an object of the disclosure to provide a tread for a tire, which tread can improve drainage capability even with reduced groove depth, while maintaining satisfactory reduction on groove resonance and productivity for manufacturing such tread.

The present disclosure provide a tread for a tire having a contact face intended to come into contact with ground during rolling and comprising at least one primary groove having depth D and delimited by two opposite groove sidewalls, these groove sidewalls being axially connected by a groove bottom, the primary groove being provided with a plurality of closing devices comprising at least two flexible fences, at least one first flexible fence having thickness t1 and extending from the groove bottom in a radially outward direction of the tire, and at least one second flexible fence having thickness t2 and extending from one groove sidewall toward the other groove sidewall, each the closing device covering at least equal to 70% of sectional area of the primary groove and being disposed such that at least one closing device is always located in the primary groove within a contact patch, the second flexible fence having a bottom edge extending along and apart from the groove bottom and a top edge extending substantially parallel to the contact face, the second flexible fence being shaped so as to form an angle A1 between an imaginary line connecting a free end of the top edge of the second flexible fence and a free end of the bottom edge of the second flexible fence and an imaginary line extending from the free end of the top edge in a tire radial direction, a width wb1 of the first flexible fence at the groove bottom is at most equal to 45% of a width WB of the groove bottom of the primary groove, and a width wb2 of the second flexible fence at the bottom edge is at most equal to 40% of the width WB of the groove bottom of the primary groove.

This arrangement improves drainage capability in particular when groove depth is reduced with tread wear, while maintaining satisfactory reduction on groove resonance and productivity for manufacturing such tread.

According the above arrangement, the primary groove is provided with the plurality of closing devices comprising at least two flexible fences so as to cover at least equal to 70% of the cross sectional area of the primary groove and being disposed such that at least one closing device is always located in the primary groove within the contact patch during rolling. Therefore, the length of the air column of the primary groove formed with the road surface is different from that formed in case there is no closing device, and the peak of groove resonance is shifted to outside of the frequency range audible to the human ear. As a result, groove resonance due to air column resonance of the primary groove can be improved.

Since the width wb1 of the first flexible fence at the groove bottom is at most equal to 45% of the width WB of the groove bottom of the primary groove, satisfactory space for drainage can be maintained even with reduced groove depth with wear in which the first flexible fence becomes difficult to bend with hydrodynamic pressure of the liquid. As a result, drainage capability of the primary groove with reduced groove depth can be improved.

If the width wb1 of the first flexible fence at the groove bottom is more than 45% of the width WB of the groove bottom of the primary groove, there is a risk that drainage capability of the primary groove with reduced groove depth cannot be maintained. By setting this width wb1 of the first flexible fence at most equal to 45% of the width WB of the groove bottom of the primary groove, drainage capability of the primary groove with reduced groove depth can be improved. This width wb1 of the first flexible fence at the groove bottom is preferably at most equal to 40% of the width WB of the groove bottom of the primary groove.

The width wb2 of the second flexible fence of the closing device at the bottom edge is at most equal to 40% of the width WB of the groove bottom of the primary groove. Therefore, it is possible to avoid occurrence of cracking during molding and demolding of the second flexible fence, in particular around an area where the bottom edge of the second flexible fence is connected to the groove sidewall as enough flexibility of the second flexible fence during molding and demolding is secured. As a result, productivity of the tread is maintained.

If the width wb2 of the second flexible fence at the bottom edge is more than 40% of the width WB of the groove bottom of the primary groove, there is a risk that cracking of the second flexible fence during molding and demolding occurs in particular an area where the bottom edge of the second flexible fence is connected to the groove sidewall. By setting this width wb2 of the second flexible fence at the bottom edge to at most equal to 40% of the width WB of the groove bottom of the primary groove, productivity of the tread is maintained. This width wb2 of the second flexible fence at the bottom edge is preferably at most equal to 35%, more preferably at most equal to 30% of the width WB of the groove bottom of the primary groove.

In another preferred embodiment, the first flexible fence and the second flexible fence do not overlap in a circumferential direction.

According to this arrangement, manufacturing of the tread with the flexible fences becomes easier, as both the first and the second flexible fences can be manufactured with simple tool, for example with the molding element as described in WO2013/076233, thus productivity of the tread can further be improved.

In another preferred embodiment, the angle A1 is between −25° and 25°.

According to this arrangement, it is possible to further avoid occurrence of cracking during molding and demolding of the second flexible fence, in particular around an area where the bottom edge of the second flexible fence is connected to the groove sidewall as enough flexibility of the second flexible fence during molding and demolding is secured further.

If the angle A1 is less than −25° or more than 25°, there is a risk that cracking of the second flexible fence during molding and demolding occurs in particular an area where the bottom edge of the second flexible fence is connected to the groove sidewall even width wb2 of the second flexible fence at the bottom edge is limited to at most equal to 40% of the width WB of the groove bottom of the primary groove. By setting this angle A1 between −25° and 25°, productivity of the tread is maintained. This angle A1 is preferable between −20° and 20°, more preferably between −18° and 18°.

In another preferred embodiment, the closing device include one first flexible fence and two second flexible fences and each of second flexible fences extends from each of opposite groove sidewalls.

According to this arrangement, it is possible to effectively cover as broader cross sectional area of the primary groove as possible by the closing device, while maintaining good productivity of the tread with the flexible fences as closing device, as the sectional area covered by each flexible fence can be reduced using simple tool for manufacturing the tread with the flexible fences as the closing device.

In another preferred embodiment, the thickness t1 of the first flexible fence is different from the thickness t2 of the second flexible fence.

According to this arrangement, performance compromise by the flexible fences can be achieved. By making the thickness t1 of the first flexible fence thicker than the thickness t2 of the second flexible fence, it is possible to have a regular wear of the first flexible fence with tread wear by increased bending rigidity of the first flexible fence relative to the second flexible fence. Contrarily by making the thickness t1 of the first flexible fence thinner than the thickness t2 of the second flexible fence, it is possible to have easier bending of the first flexible fence even with reduced groove depth which results further improvement on drainage capability.

### BRIEF DESCRIPTION OF THE DRAWINGS

Other characteristics and advantages of the disclosure arise from the description made hereafter in reference to the annexed drawings which show, as nonrestrictive examples, the embodiments of the disclosure.

In these drawings:

FIG. 1 is a schematic view of a portion of a tread for a tire according to a first embodiment of the present disclosure;

FIG. 2 is an enlarged schematic view showing a portion indicated as II in FIG. 1;

FIG. 3 is a schematic cross sectional view taken along line in FIG. 1;

FIG. 4 is an enlarged schematic view of a portion according to a second embodiment of the present disclosure;

FIG. 5 is a schematic cross sectional view according to the second embodiment of the present disclosure;

FIG. 6 is an enlarged schematic view of a portion according to a third embodiment of the present disclosure; and

FIG. 7 is a schematic cross sectional view according to the third embodiment of the present disclosure.

### DETAILED DESCRIPTION OF THE ENABLING EMBODIMENTS

Preferred embodiments of the present disclosure will be described below referring to the drawings.

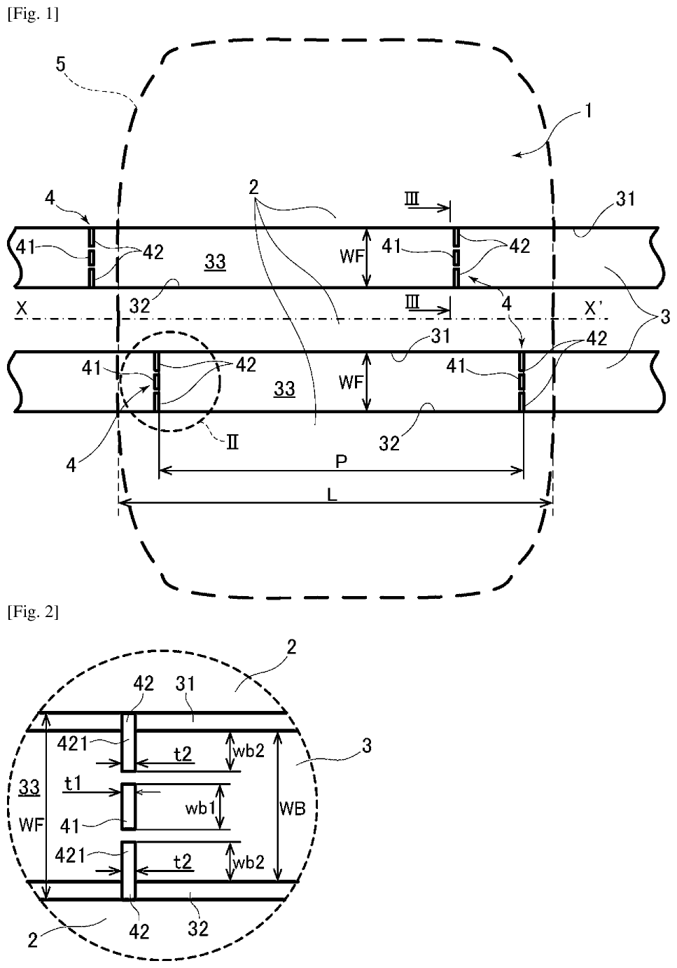

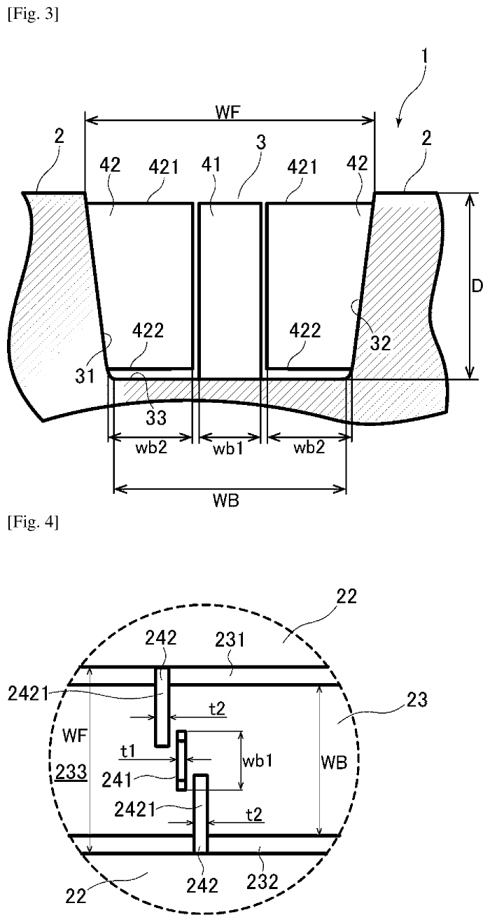

A tread 1 for a tire according to a first embodiment of the present disclosure will be described referring to FIGS. 1, 2 and 3. FIG. 1 is a schematic view of a portion of a tread 1 according to the first embodiment of the present disclosure. FIG. 2 is an enlarged schematic view showing a portion indicated as II in FIG. 1. FIG. 3 is a schematic cross sectional view taken along line in FIG. 1.

The tread 1 is a tread for a tire having dimension 225/45R17 and comprises a contact face 2 intended to come into contact with the ground during rolling, a plurality of primary grooves 3 extending in a tire circumferential direction indicated as XX′. The primary grooves 3 are delimited by two groove sidewalls 31, 32 facing each other and being connected by a groove bottom 33. The primary groove 3 has a width WF at a level of the contact face 2 and a depth D (as shown in FIG. 3). The groove bottom 33 has a width WB which is narrower than the width WF at the level of contact face 2.

As shown in FIG. 1, a contact patch 5 has a contact patch length L in a tire circumferential direction when the tire with the tread 1 is mounted onto its standard rim and inflated at its nominal pressure and its nominal load is applied. According to ‘ETRTO Standard Manual 2015’ the standard rim for this size is 7.5 J, the nominal pressure is 250 kPa and the nominal load is 615 kg.

As shown in FIG. 1, in the primary groove 3, a plurality of closing devices 4 is provided. The closing device 4 comprises one first flexible fence 41 and two second flexible fences 42 for dividing an air column created with the ground and the primary groove 3 in the contact patch 5 during rolling. Each closing device 4 is spaced from each other by distance P in the tire circumferential direction in the primary groove 3. The distance P is shorter than the contact patch length L such that at least one closing device 4 in each primary groove 3 is always located in the contact patch 5 during rolling.

The closing device 4 comprises one first flexible fence 41 having a thickness of t1 and extending from the groove bottom 33 of the primary groove 3 in a radially outward direction of the tire and two second flexible fences 42 having a thickness of t2 and extending from one of the groove sidewalls 31, 32 of the primary groove 3 toward the opposite groove sidewall 32, 31 of the same primary groove 3. Each the closing device 4 covers at least equal to 70% of the cross sectional area of the primary groove 3, while radially outermost portion of each the flexible fences are radially inwardly offset from the level of the contact face 2, as shown in FIGS. 2 and 3.

The width (axial length) wb1 of the first flexible fence 41 at the groove bottom 33 is set at most equal to 45% of the width (axial length) WB of the groove bottom 33 of the primary groove 3. In the first embodiment, this width wb1 of the first flexible fence 41 at the groove bottom 33 is equal to 4.0 mm, which is 34% of the width WB of the groove bottom 33 of the primary groove 3.

The second flexible fence 42 has a bottom edge 422 and a top edge 421. The bottom edge 422 axially extends in parallel to the groove bottom 33 at a level upwardly spaced from the groove bottom 33 defining an axially extending narrow gap therebetween. The top edge 421 axially extends substantially parallel to the contact face 2 at a level downwardly spaced from the contact face 2. In the present embodiment, a free or distal end of the top and bottom edges 421, 422 are radially aligned.

The width (axial length) wb2 of the second flexible fence 42 at the bottom edge 422 is set at most equal to 40% of the width (axial length) WB of the groove bottom 33. In this first embodiment, this width wb2 of the second flexible fence 42 at the bottom edge 422 of the same second flexible fence 42 is equal to 2.4 mm, which is 20% of the width WB of the groove bottom 33 of the primary groove 3.

As shown in FIGS. 2 and 3, between a free or distal end side edge of the second flexible fence 42 and a side edge of the first flexible fence 41, a radially extending narrow gap is formed. Thus, the first flexible fence 41 and the second flexible fence 42 are shaped so as not to overlap in a circumferential direction.

Further, the second flexible fence 42 is shaped so as to form an angle A1 between an imaginary line connecting the free ends of the top edge 421 and bottom edge 422 and an imaginary line extending from a free end of the top edge 421 in a tire radial direction. In this first embodiment, since the free ends of the top edge 421 and bottom edge 422 are radially aligned, this angle A1 is 0° and not shown in FIGS. 1, 2 and 3.

The tread 1 has the same structure as the conventional tread except for an arrangement regarding the closing device 4 and is intended to be applied to a conventional pneumatic radial tire and other non-pneumatic tire. Thus, description of the internal construction of the tread 1 will be omitted.

The primary groove 3 is provided with the plurality of closing devices 4 each covering at least equal to 70% of the radial sectional area of the primary groove 3 and being disposed such that at least one closing device 4 is always located in the contact patch 5. Therefore, the length of the air column formed by the primary groove 3 in the contact patch 5 is shifted to a length whose groove resonance peak is outside of the frequency audible range for the human ear. Thus, groove resonance due to air column resonance of the primary groove 3 can be harmless.

The second flexible fence 42 of the closing device 4 is provided so as to have the bottom edge 422 facing to the groove bottom 33 and the width wb1 of the first flexible fence 41 at the groove bottom 33 is at most equal to 45% of the width WB of the groove bottom 33 of the primary groove 3. Satisfactory space for drainage can be maintained even with reduced groove depth with wear in which the first flexible fence 41 becomes difficult to bend with hydrodynamic pressure of the water. As a result, drainage capability of the primary groove 3 with reduced groove depth can be improved. This width wb1 of the first flexible fence 41 at the groove bottom 33 is preferably at most equal to 40% of the width WB of the groove bottom 33 of the primary groove 3.

The width wb2 of the second flexible fence 42 of the closing device 4 at the bottom edge 422 is at most equal to 40% of the width WB of the groove bottom 33 of the primary groove 3. Therefore, it is possible to avoid occurrence of cracking during molding and demolding of the second flexible fence 42, in particular around an area where the bottom edge 422 of the second flexible fence 42 is connected to the groove sidewall 31, 32 as enough flexibility of the second flexible fence 42 during molding and demolding is secured. As a result, productivity of the tread 1 is maintained. This width wb2 of the second flexible fence 42 at the bottom edge 422 is preferably at most equal to 35%, more preferably at most equal to 30% of the width WB of the groove bottom 33 of the primary groove 3.

The first flexible fence 41 and the second flexible fence 42 do not overlap in a circumferential direction. Manufacturing of the tread 1 with the closing device 4 (the flexible fences 41, 42) becomes easier, as both the first and the second flexible fences 41, 42 can be manufactured with simple tool, for example with the molding element as described in WO2013/076233, thus productivity of the tread can further be improved.

The closing device 4 comprises one first flexible fence 41 and two second flexible fences 42 extending from the opposite groove sidewalls 31, 32. It is possible to effectively cover major part of the cross sectional area of the primary groove 3 by the closing device 4, while maintaining good productivity of the tread 1 with the flexible fences 41, 42 as closing device 4, as the sectional area covered by each flexible fence 41, 42 can be reduced using simple tool for manufacturing the tread 1 with the flexible fences 41, 42 as the closing device 4.

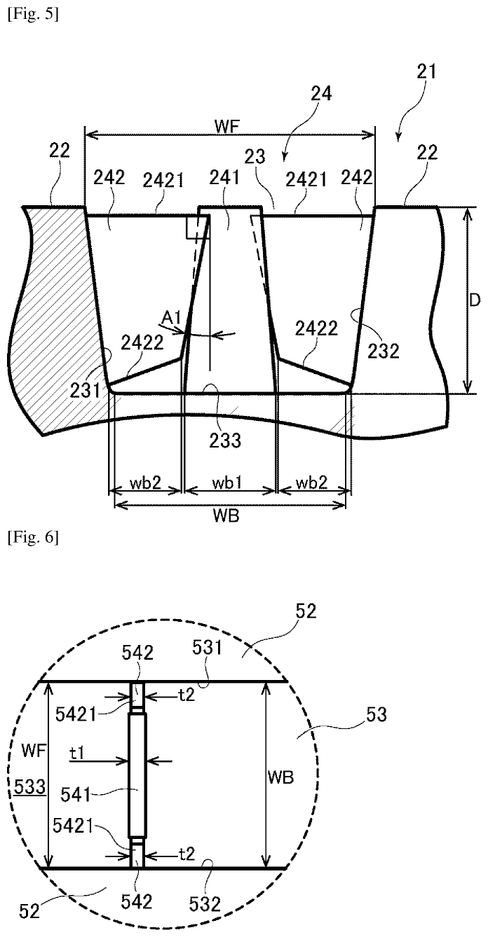

A tread 21 according to a second embodiment of the present disclosure will be described referring to FIGS. 4 and 5. FIG. 4 is an enlarged schematic view of a portion according to the second embodiment of the present disclosure. FIG. 5 is a schematic cross sectional view according to the second embodiment of the present disclosure. The constitution of this second embodiment is similar to that of the first embodiment other than the arrangement shown in FIGS. 4 and 5, thus description will be made referring to FIGS. 4 and 5.

In the second embodiment, the closing device 24 comprises one first flexible fence 241 having a thickness of t1 and extending from the groove bottom 233 of the primary groove 23 and two second flexible fences 242 having a thickness of t2 and extending from each of the opposite groove sidewalls 231, 232. Two second flexible fences 242 are offset each other in a circumferential direction in the primary groove 23. The first flexible fence 241 is placed at a position circumferentially between two second flexible fences 242, 242 and circumferentially offset from both of the second flexible fences 242 in the primary groove 23. The thickness t1 of the first flexible fence 241 is thinner than the thickness t2 of the second flexible fence 242, as shown in FIG. 4. The first and the second flexible fences 241, 242 partly overlap in a circumferential direction. The first and the second flexible fences 241, 242 cover at least equal to 70% of the cross sectional area of the primary groove 23, as shown in FIG. 5.

The first flexible fence 241 has an upwardly tapered trapezoid shape. The width wb1 of the first flexible fence 241 at the groove bottom 233 of the primary groove 23 is set at most equal to 45% of the width WB of the groove bottom 233. The first flexible fence 241 radially extends to a level substantially equal to that of the contact face 22. This width wb1 of the first flexible fence 241 at the groove bottom 233 is equal to 4.5 mm, which is 38% of the width WB of the groove bottom 233 of the primary groove 23.

A bottom edge 2422 of the second flexible fence 242 extends obliquely upwardly from the groove sidewall 231, 232 so as to form a triangular space thereunder. A top edge 2421 of the second flexible fence 242 extends substantially parallel to the contact face 22 at a level below the contact face 22. The width wb2 of the flexible fence 242 at the bottom edge 2422 (length of the bottom edge 2422 in tire axial direction) is set at most equal to 40% of the width WB of the groove bottom 233. In this second embodiment, this width wb2 of the second flexible fence 242 at the bottom edge 2422 is equal to 3.5 mm, which is 30% of the width WB of the groove bottom 233 of the primary groove 23.

The second flexible fence 242 is shaped so as to form an angle A1 between an imaginary line connecting a free or distal ends of the top edge 2421 and the bottom edge 2422 and an imaginary line extending in a tire radial direction. In this second embodiment, this angle A1 is −10°.

The angle A1 may be between −25° and 25°. If the angle A1 is less than −25° or more than 25°, there is a risk that cracking of the second flexible fence during molding and demolding occurs in particular an area where the bottom edge of the second flexible fence is connected with the groove sidewall even width wb2 of the second flexible fence at the bottom edge is limited to at most equal to 40% of the width WB of the groove bottom of the primary groove. By setting this angle A1 between −25° and 25°, productivity of the tread is maintained. This angle A1 is preferable between −20° and 20°, more preferably between −18° and 18°.

The thickness t1 of the first flexible fence 241 is thinner than the thickness t2 of the second flexible fence 242. It is possible to have easier bending of the first flexible fence 241 even with reduced groove depth, which results further improvement on drainage capability. Both the thickness t1 of the first flexible fence 241 and the thickness t2 of the second flexible fence 242 is preferably less than or equal to 1.5 mm, more preferably between 1.0 mm and 0.2 mm, and a gap between two thicknesses t1 and t2 is preferably less than or equal to 1.0 mm, more preferably less than or equal to 0.5 mm.

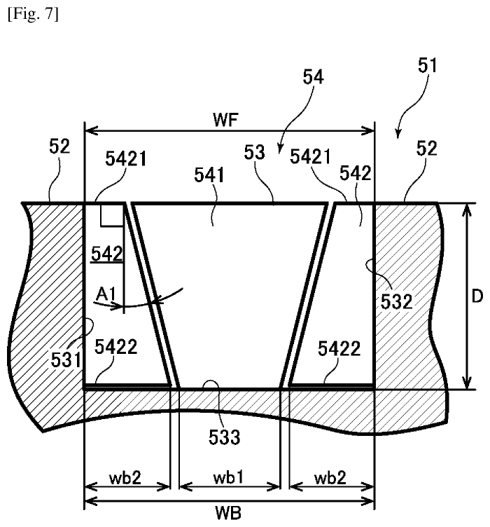

A tread 51 according to a third embodiment of the present disclosure will be described referring to FIGS. 6 and 7. FIG. 6 is an enlarged schematic view of a portion according to the third embodiment of the present disclosure. FIG. 7 is a schematic cross sectional view according to the third embodiment of the present disclosure. The constitution of this third embodiment is similar to that of the first embodiment other than the arrangement shown in FIGS. 6 and 7, thus description will be made referring to FIGS. 6 and 7.

In the third embodiment, the closing device 54 comprises one first flexible fence 541 having thickness t1 and extending from the groove bottom 533 of the primary groove 53 and two second flexible fences 542 having the thickness t2 and extending from each of the opposite groove sidewalls 531, 532. The thickness t1 of the first flexible fence 541 is thicker than the thickness t2 of the second flexible fence 542, as shown in FIG. 6.

As shown in FIGS. 6 and 7, between the free or distal end of the second flexible fence 542 and the side edge of the first flexible fence 541, a radially extending narrow gap is formed. Thus, the first flexible fence 541 and the second flexible fence 542 are shaped so as not to overlap in a circumferential direction. The first and the second flexible fences 541, 542 cover at least equal to 70% of the sectional area of the primary groove 53, as shown in FIG. 7.

The first flexible fence 541 has an upwardly tapered trapezoid shape. The width wb1 of the first flexible fence 541 at the groove bottom 533 of the primary groove 53 is set at most equal to 45% of the width WB of the groove bottom 533. The first flexible fence 541 radially extends to a level substantially equal to the contact face 52. In this third embodiment, this width wb1 of the first flexible fence 541 at the groove bottom 533 is equal to 7.4 mm, which is 35% of the width WB of the groove bottom 533 of the primary groove 53.

The bottom edge 5422 of the second flexible fence 542 axially extends in substantially parallel to the groove bottom 533 at a level upwardly spaced from the groove bottom 533 defining an axially extending narrow gap therebetween. The top edge 5421 of the second flexible fence 542 axially extends substantially parallel to the contact face 52 at the level of the contact face 52.

The width wb2 (axial length) of the second flexible fence 542 at the bottom edge 5422 is set at most equal to 40% of the width WB of the groove bottom 533. In this third embodiment, this width wb2 of the second flexible fence 542 at the bottom edge 5422 is equal to 6.3 mm, which is 30% of the width WB of the groove bottom 533.

As shown in FIGS. 6 and 7, between the free or distal end of the second flexible fence 542 and the side edge of the first flexible fence 541, radially obliquely extending narrow gaps are formed. Thus, the first flexible fence 541 and the second flexible fence 542 are shaped so as not to overlap in a circumferential direction.

The second flexible fence 542 is shaped so as to form an angle A1 between an imaginary line connecting the free ends of the top edge 5421 and the bottom edge 5422 of the second flexible fence 542 and an imaginary line extending from the free end of the top edge 5421 in a tire radial direction. In this third embodiment, this angle A1 is 15°.

The thickness t1 of the first flexible fence 541 is thicker than the thickness t2 of the second flexible fence 542. Therefore, it is possible to have a regular wear of the first flexible fence 541 with tread wear by increased bending rigidity of the first flexible fence 541 relative to the second flexible fence 542.

The disclosure is not limited to the examples described and represented and various modifications can be made there without leaving its framework.

### Examples

In order to confirm the effect of the present disclosure, one type of pneumatic tire of Example to which the present disclosure is applied and other type of pneumatic tire of Reference were prepared. An internal construction of these tires other than tread was typical radial tire construction for passenger car tire.

The Example was a pneumatic tire having a tread as described in the above first embodiment. The Reference was a pneumatic tire having a tread same as the Example but provided without closing device in a primary groove. Both tires were mounted onto a rim of 7.5J×17, and inflated to 220 kPa.

Noise Test:

Unused test tires were mounted onto all four wheels of a 1,400 cc front-wheel drive vehicle. On a straight pass surface conform to standard ISO 10844: 2011, so-called “coast-by” noise in accordance with standard ISO 13325 at a speed of 80 km/h during coasting with engine cut-off and at neutral gear position was measured. The results are shown in table 1. In this table 1, results are represented by a gap of weighted sound pressure level in decibel (dB(A)) over the Reference (Reference=0 dB(A)), lower the value indicates better the noise performance.

Hydroplaning Test:

Unused test tires were mounted onto all four wheels of a 1,400 cc front-wheel drive vehicle. On a straight pass asphalt surface provided with a pool filled with approximately 8 mm deep water, a speed at which one of two driving wheels reaches 10% slip ratio during passage of the pool was measured. The results are shown in table 1 also. In this table 1, results are represented by an index of 100 for the Reference, higher the number indicates better the hydroplaning performance.

TABLE 1

| | Example | Reference |
|---|---|---|
| Noise performance (dB(A)) | −2.1 | 0.0 |
| Hydroplaning performance (index) | 99 | 100 |

As seen from table 1, the Example tire shows important improvement on noise performance while maintaining equivalent hydroplaning performance.

### REFERENCE SIGNS LIST

1, 21, 51 tread
2, 22, 52 contact face
3, 23, 53 primary groove
31, 231, 531 groove sidewall of the primary groove
32, 232, 532 groove sidewall of the primary groove
33, 233, 533 groove bottom of the primary groove
4, 24, 54 closing device
41, 241, 541 first flexible fence
42, 242, 542 second flexible fence
421, 2421, 5421 top edge of the second flexible fence
422, 2422, 5422 bottom edge of the second flexible fence contact patch

1. A tread for a tire having a contact face intended to come into contact with ground during rolling and comprising at least one primary groove having depth D and delimited by two opposite groove sidewalls, these groove sidewalls being axially connected by a groove bottom, the primary groove being provided with a plurality of closing devices including at least two flexible fences, at least one first flexible fence having thickness t1 and extending from the groove bottom in a radially outward direction of the tire, and at least one second flexible fence having thickness t2 and extending from one groove sidewall toward the other groove sidewall, each the closing device covering at least equal to 70% of sectional area of the primary groove and being disposed such that at least one closing device is always located in the primary groove within a contact patch, the second flexible fence having a bottom edge extending along and apart from the groove bottom and a top edge extending substantially parallel to the contact face, the second flexible fence being shaped so as to form an angle A1 between an imaginary line connecting a free end of the top edge of the second flexible fence and a free end of the bottom edge of the second flexible fence and an imaginary line extending from the free end of the top edge in a tire radial direction, a width wb1 of the first flexible fence at the groove bottom is at most equal to 45% of a width WB of the groove bottom of the primary groove, and wherein a width wb2 of the second flexible fence at the bottom edge is at most equal to 40% of the width WB of the groove bottom of the primary groove.

2. The tread according to claim 1, wherein the first flexible fence and the second flexible fence do not overlap in a circumferential direction.

3. The tread according to claim 1, wherein the angle A1 is between −25° and 25°.

4. The tread according to claim 1, wherein the closing device includes one first flexible fence and two second flexible fences and each of the second flexible fences extends from each of opposite groove sidewalls.

5. The tread according to claim 1, wherein the width wb1 of the first flexible fence at the groove bottom of the primary groove is at most equal to 40% of the width WB of the groove bottom of the primary groove, and the width wb2 of the second flexible fence at the bottom edge is at most equal to 30% of the width WB of the groove bottom of the primary groove.

6. The tread according to claim 1, wherein the thickness t1 of the first flexible fence is different from the thickness t2 of the second flexible fence.

7. (canceled)
